(19) United States
(12) Patent Application Publication
(10) Pub. No.: US 2014/0108323 A1
(43) Pub. Date: Apr. 17, 2014

(54) Compressively-accelerated read mapping

(71) Applicants: Bonnie Berger Leighton, Newtonville, MA (US); Deniz Yörükoglu, Cambridge, MA (US)

(72) Inventors: Bonnie Berger Leighton, Newtonville, MA (US); Deniz Yörükoglu, Cambridge, MA (US)

(21) Appl. No.: 14/053,387

(22) Filed: Oct. 14, 2013

Related U.S. Application Data
(60) Provisional application No. 61/712,900, filed on Oct. 12, 2012.

(51) Int. Cl. G06N 5/02

(52) U.S. Cl. CPC G06N 5/022
USPC 706/50

(57) ABSTRACT

A genomic read dataset is mapped from multiple individuals to a reference genome in a time- and storage-efficient manner. The approach begins by building a set of data structures that collectively represents a knowledge base of similarity information. The knowledge base comprises a set of data structures that, when combined, intrinsically represent all reads to whole-reference match (similarity) information for a reference genome. After this knowledge base is generated, it is then accessed and used in a mapping decision layer. The mapping layer taps into the similarity knowledge within the set of data structures to decide on the mappings and report them, thereby avoiding redundant and unnecessary computations that would otherwise be necessary to find matches and report mappings for each read individually. The approach exploits the redundancy in the read datasets to enable significant speed-up of the sequence matching layer, which preferably is performed collectively for all reads.

### BACKGROUND

1. Technical Field

This disclosure relates generally to genomic sequencing and, in particular, techniques and methods for working with large genomes and large sets of short reads.

2. Background of the Related Art

Next-generation sequencing (NGS) tools produce short reads or short read pairs, which typically are short sequences of less than a few hundred bases. To compare the DNA of the sequenced sample to its reference sequence, it is necessary to find the corresponding part of that sequence for each read in the sequencing data. This mapping of the reads against the reference sequence is known as “read mapping” or aligning. By definition, reads do not come with position information; thus, the sequence of the read itself must be used to find the corresponding region in the reference sequence. The reference sequence, however, typically is very large, which makes it difficult to find a matching region. To address this problem, it is well-known to provide read mapping tools or “mappers.” One such tool, Bowtie, is described as an ultrafast, memory-efficient short read aligner that aligns short reads to the human genome at a rate of tens of millions of reads per hour on a typical workstation. According to the developers, Bowtie may be configured to enable a number of parallel search threads to exploit multiple processor cores. Other read mapping programs exploit other algorithms and supporting technologies, with the various programs and approaches differing in various ways (e.g., input data size, speed and scalability, memory requirements, sensitivity, ease of installation and use, configurability, match handling, and the like). Once mapping is performed, a sample can be examined to attempt to identify and locate variations.

Read mappers typically include distinct matching and mapping decision layers and operate as follows. Reads are scanned one-by-one, and matches are identified between the read sequence and regions of the reference genome within a similarity threshold. The similarity threshold differs from mapper to mapper. After a certain number of mapping regions that pass a threshold are identified, one, some or all of these mappings are reported depending on biologically relevant “intelligent” decisions of the mapper. The portion of the solution space that these tools search before they stop also differs across mappers, but typically the less they cover the less reliable and useful the output mappings. Despite these differences, the two computation layers (matching and mapping) are always interleaved. This approach, however, is inefficient (from a processing and memory requirements point-of-view), in large part because often the computation time during the matching phase fails to result in a useful read mapping worth reporting.

The techniques described herein address these inefficiencies.

### BRIEF SUMMARY

According to this disclosure, an NGS read dataset is mapped from multiple individuals to a reference genome in a time- and storage-efficient manner as compared to known techniques. In this approach, in effect the matching and mapping decision layers are separated and performed as a joint (concurrent) computation. To this end, the approach begins with a pre-processing stage in which a knowledge base of similarity information is generated. Preferably, the knowledge base of similarity information comprises a set of data structures that, when combined, intrinsically represent all reads to whole-reference match (similarity) information for the reference genome. This pre-processing takes advantage of the observation that, as read datasets become more redundant, much of the computation involved in identifying similar sequence matches between the reference genome and the reads gets repeated (if not explicitly, then at least inherently because each individual's genome is about 99.5% identical to another person's genome). Thus, with respect to a large number of people's read datasets, the redundancy of the overall dataset is significantly higher than the redundancy within an individual genome. After this knowledge base of similarity information is generated, it is then accessed and used in the mapping decision layer, and this layer may leverage conventional mapping tools (e.g., Bowtie, BWA, or the like). In particular, the mapping layer taps into the similarity knowledge within the set of data structures to decide on the mappings and report them, thereby avoiding redundant and unnecessary computations that would otherwise be necessary (to find matches and report mappings for each read individually). In other words, the approach of this disclosure exploits the redundancy in the read datasets to enable significant speed-up of the sequence matching layer, which preferably is performed collectively for all reads. This approach is sometimes referred to herein as compressively-accelerated read mapping, or compressive mapping for short.

Preferably, the knowledge base of similarity information comprises three (3) data structures: a compressed read repository, a homology table, and a read links table. The compressed read repository is constructed from input read data. Identical (or partially identical) reads are collapsed, and the remaining reads are compressed with respect to the reference genome to reduce redundancy in the read dataset. As an option, divergent reads that cannot be compressed efficiently against the reference are assembled, and additional reference scaffolds are generated for further compression. The homology table, which needs to be built only once for each reference genome, is constructed for the reference genome sequence(s). The homology table stores homologies among all medium-sized (e.g., read length) regions of the reference genome within a predefined similarity. This table enables direct retrieval of all homologous loci of any given locus of a reference, thereby enabling access to all mapping locations of a read at relatively low cost and with significant accuracy. The read links table comprises a set of pointers to the compressed read repository with additional edit information to enable reconstruction of the original read information (from the compressed read repository) using the pointer and edit information within a link. As an option, edits that commonly appear in many read links are further integrated to the read repository for higher read mapping accuracy. With this knowledge base of similarity information, the mapping layer (e.g., an off-the-shelf read mapping program) is then used to build coarse alignments between the reference genome and the compressed read repository. Then, by exploiting the compact representation of the compressed read repository and using the homology table, the complete read mapping output from these alignments is constructed. In effect, the technique searches for seeds extracted from the compressed read repository, and it then refines the search results by efficiently reconstructing the desired set of reads—across all individuals in the read repository—that are relevant to the reference genomic region being investigated. As noted above, the approach avoids unneeded computation and maps the entire read data set significantly faster than existing methods.

The foregoing has outlined some of the more pertinent features of the subject matter. These features should be construed to be merely illustrative.

### BRIEF DESCRIPTION OF THE DRAWINGS

For a more complete understanding of the disclosed subject matter and the advantages thereof, reference is now made to the following descriptions taken in conjunction with the accompanying drawings, in which:

FIG. 1 is a block diagram illustrating a conventional read mapping algorithm;

FIG. 2 is a block diagram illustrating the compressively-accelerated read mapping technique of this disclosure;

FIG. 3 is a block diagram illustrating a preferred embodiment of the compressive mapping for next-generation sequencing; and

FIG. 4 is a graph illustrating comparisons of various read mappers using existing methods versus the compressively-accelerated read mapping framework of this disclosure.

### DETAILED DESCRIPTION OF AN ILLUSTRATIVE EMBODIMENT

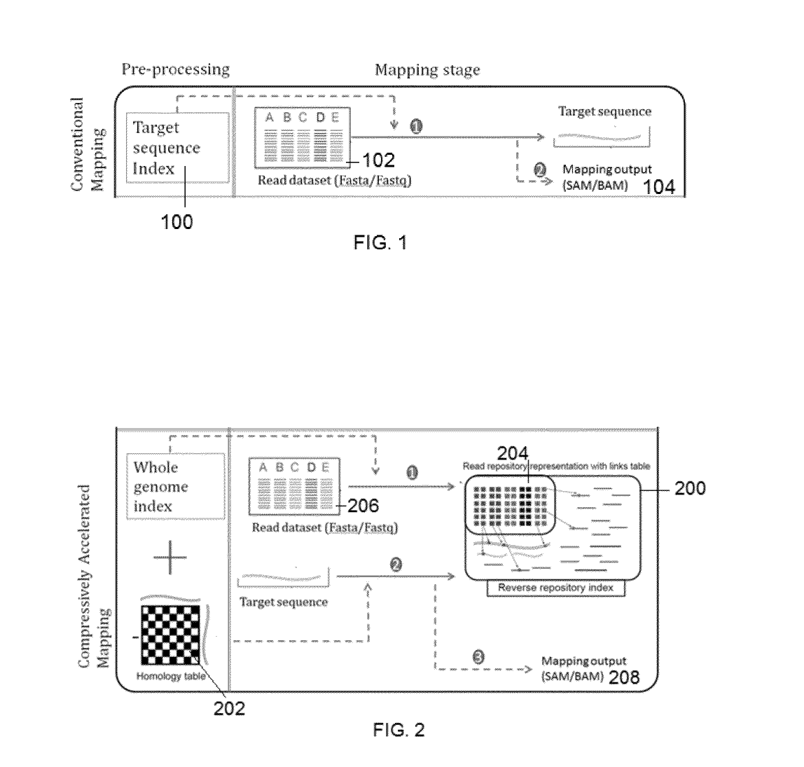

FIG. 1 illustrates a conventional read mapping algorithm. In the conventional approach, and during a pre-processing stage, a target sequence index 100 of a reference genome is constructed. In the mapping stage, a conventional read mapping method processes reads 102 one-by-one, matching seeds within a read with the index 100 and outputting either all (or a selectively-filtered subset) of matching loci 104.

FIG. 2 illustrates the compressively-accelerated read mapping technique (or “framework”) of this disclosure. This approach also includes a pre-processing stage, and a mapping stage, but each of these stages differs as compared to the conventional technique shown in FIG. 1. In the pre-processing stage, a set of data structures that collectively represent a knowledge base of similarity information is generated. The knowledge base of similarity information intrinsically represents all reads to whole-reference match (similarity) information for the reference genome. Preferably, the knowledge base of similarity information comprises three (3) data structures: a compressed read repository 200, a homology table 202, and a read links table 204. The compressed read repository 200 is constructed from input read data 206 (e.g., short reads, short read pairs and paired-end reads). To create the compressed read repository 200, identical (or partially identical) reads are collapsed, and the remaining reads are compressed with respect to the reference genome to reduce redundancy in the read dataset. As an option, divergent reads that cannot be compressed efficiently against the reference are assembled, and additional reference scaffolds are generated for further compression. The result is a compact data structure that compressively represents the read dataset. The homology table 202 stores homologies among all medium-sized (e.g., read length) regions of the reference genome within a predefined similarity. Table 202 enables direct retrieval of all homologous loci of any given locus of a reference; as described below, this facilitates access to all mapping locations of a read at relatively low cost and with significant accuracy. The read links table 204 comprises a set of pointers to the compressed read repository with additional edit information to enable reconstruction of the original read information (from the compressed read repository) using the pointer and edit information within a link. As another option, edits that commonly appear in many read links are further integrated to the read repository for higher read mapping accuracy.

Using this approach, and instead of mapping reads to the reference genome (e.g., using the index 100 in FIG. 1), the mapping stage (with information from the homology table 202) matches loci within the reference to the compact read repository 200. The mapping layer may use an off-the-shelf read mapping program such as Bowtie, BWA, or one or many others. In operation, the mapping program initially builds coarse alignments between the reference genome and the compressed read repository 200. It then uses the compact representation and information from the homology table 202 to construct the complete read mapping output 208 from these alignments. This mapping paradigm (sometimes referred to herein as “reverse direction” mapping) enables a variety of options for the mapping stage including, without limitation, robust selective filtering on-the-fly, as well as finding all reads within the repository that match with a relatively short sequence of interest that does not exist in the reference genome (e.g., novel insertions, haplotypes, containment sequences, and others).

This approach obviates mapping of each read to a reference index (such as index 100 in FIG. 1). In effect, the technique searches for seeds extracted from the compressed read repository, and it then refines the search results by efficiently reconstructing the desired set of reads—across all individuals in the read repository—that are relevant to the reference genomic region being investigated. As noted above, the approach avoids unneeded computation and maps the entire read data set significantly faster than existing methods.

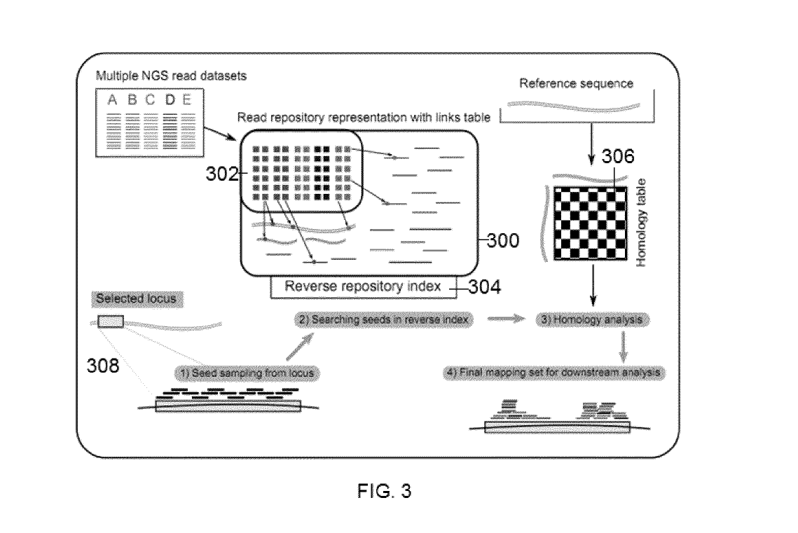

FIG. 3 illustrates the compressively-accelerated read mapping technique of this disclosure in more detail. As noted, the framework compressively represents NGS read data from multiple individuals in such a way as to facilitate fast locus-specific analysis using several data structures: a compressed database consisting of a read repository 300 with links-table 302; an associated reverse-index 304 of the compressed read repository, and a homology table 306 of the reference identifying similar regions within it. These structures are computed once in a pre-processing phase. Subsequently, reads corresponding to loci of interest 308 are identified from the compressed repository using the illustrated processing pipeline: at step (1) short seeds are sampled from the locus sequence; at step (2) sampled seeds are looked up in the reverse-index 304, obtaining hits in the repository; at step (3) regions homologous to seed hits are obtained from the homology table 306; and at step (4) a final mapping is done using homology knowledge. The final mapping set can then be used for downstream expression or variation analysis.

Thus, during pre-processing, the framework generates a compact repository that allows rapid retrieval and realignment of reads relevant to a locus. By compressively representing sequencing reads in this manner, fast lookup of relevant reads (without decompressing the whole library) is facilitated, and then the homology table of the reference genome is used to efficiently and accurately generate locus-to-read alignment results.

The compressed read repository 300 and link table 302 reduce the size of the read data sets and provide data structures that are as compact as possible while allowing efficient indexing of the reads for reverse mapping without required decompression. Without limitation, a relatively simple and efficient way of performing this is to generate a set of long sequences to serve as a source for reproducing all reads, such that each read will be represented with: (1) a pointer to a highly similar location within the source sequences; and (2) a small number of edit operations that represent differences between the read and the homologous region in the source. This approach is analogous to a known “links plus edits” compression scheme, although its purpose is to compress short-read sequences across multiple samples rather than multiple genomes. The algorithmic problem in this stage is to efficiently generate a source sequence library that is compact and a links-table that can be represented with minimal edits. A simple method for generating the source sequence library is as follows: (i) obtain the reference genome sequence for the species if available (since a reference genome likely contains homologous regions for a majority of the reads), (ii) identify intervals within the reference that can represent reads with less than a certain number of edit operations (e.g., ≦2 substitutions), and (iii) assemble the remaining sequences in a longer super sequence so that all reads can be represented as links with few number of edits. Note that step (2) is not performed as an alignment step that tries to identify the position in the reference genome that a read is originating from, but merely as a compression step that utilizes the reference as a source library to generate links without necessarily inferring the true genomic origins of reads. Thus, in contrast to the prior art, wherein the reference index is used to identify the set of correct mappings from the read set to the reference, in compressive mapping the reference index is used only during the reference-based compression after collapsing reads. One way the reference index can be used during the reference-based compression is to quickly identify only a single similar region in the reference genome for each collapsed read with the goal of compressing the read sequences to read links, comprised of a single pointer plus edits.

The reverse-index 304 enables recovery of reads relevant to a genomic locus from the read repository 300. In one embodiment, a k-mer based indexing approach may be used. At a high level, the reverse-index 300 records the locations within the compressed representation that correspond to the occurrences of each k-mer; this index can then be used during read lookup or realignment to filter out the majority of irrelevant reads. A design issue to address while constructing a reverse-index from the read repository is to determine how many of the edits will be included in the index. An ideal reverse-index design incorporates edits that are recurrent within the links-table (likely corresponding to actual genomic variants of one or more samples), yet exclude uncommon edits that are likely to have arisen from sequencing errors. The exact frequency of an edit required to include it within the index can be chosen to adjust for the sample set, and new edits can be introduced to the index as new samples are added.

When performing analysis on a specific genomic locus, it is desirable to consider reads stored as links to other homologous loci within the reference, as some of these reads may map to the locus of interest. To this end, in the illustrated embodiment the framework employs a k-mer based homology table 306 that identifies homologous regions within the reference for all potential seed k-mer selections. In conjunction with the reverse-index, the homology table allows accurate locus-specific realignment without reprocessing the whole dataset. Such a table can be created offline and only needs to be generated once for a given reference genome, after which it can be used for mapping by multiple read repositories. The homology table also can be expanded further to additional external reference sequences that are introduced.

In a specific embodiment, once the index of the read repository is constructed, search of a given genomic loci within the repository is implemented as follows: seeds from the genomic loci are sampled, the sampled seeds are mapped using the read repository index, the seeds (possibly extended) are simultaneously analyzed against the k-mer homology table, and the matching short-read mapping set is reconstructed. This alignment process is performed for the reference seeds to the indexed read repository, rather than the conventional alignment approach of read seeds to the indexed reference.

Generalizing, the knowledge base of similarity information comprises the compressed read repository, and a high-resolution homology table is constructed for the reference genome sequence(s). A read mapping program (e.g. Bowtie, BWA, mrsFAST, or the like) is then used to build coarse alignments between the compressed read repository and the reference genome. Exploiting the compact representation of the read repository and using the homology table, the complete read mapping output from these alignments is then constructed. The approach avoids unneeded computation and maps the entire read data set significantly faster than existing methods.

The repository, index and table structures may be distinct or combined in whole or in part. Collectively, they comprise a knowledge base of similarity information. When not in use, this information (or portions thereof) is maintained in a data storage component. The individual data structures may be co-located or remote from one another. Thus, for example, the read repository may be located in association with a server, while the compact links-table may be located in association with a client.

The disclosed subject matter is not limited to any particular technique for producing the compact representation of the input data reads. As noted above, during the collapsing stage, the main aim is to remove any redundancy that is readily apparent (exact or very close to exact). There are many alternative options for this processing. One approach is to use full or partial read sequences, namely, collapsing a first half and then using the second half of the read separately. Another approach is to use an un-indexed or previously-indexed reference genome, such as a self-generated hash table that may have a fixed size (or be re-sizable) and that partly or fully represents all distinct read length k-mers within the reference genome(s). Using a reference genome during collapsing may provide an advantage of automatically creating read links for reads or partial reads that match to the reference; this approach saves time, because it obviates processing these reads (or partial reads) again for repository generation and read link creation. Still another approach is to use a de novo read clustering scheme. This alternative merges reads that are very close to each other (e.g., one nucleotide apart) and processes them jointly for the collapsing and the downstream repository/link table creation stages. Irrespective of the collapsing scheme, after it is performed, preferably what remains is a list of unique read sequences (or partial read sequences) that represent a collection of pre-collapsing stage read sequences themselves. Then, and as described above, each of these unique read sequences can then be further compressed such that each one is represented as a pointer to a location in one of the sequences within the read repository accompanied by its edit information.

The repository may or may not start with a pre-existing set of sequences including, without limitation, the reference genome or genomes of the species, the transcriptome/exome references, known insertions and haplotypes varying from the reference, as well as bacterial/viral sequences, contaminants and other sequences from related species. If there are pre-existing sets of sequences within the repository, they may be represented in their original form or in a compressed redundancy-free form. To find positions in the repository to compress the unique read sequences, as has been described, the framework may utilize an off-the-shelf mapper (which may be the same as the mapper used for the reverse mapping part). If a mapper is utilized, then the pre-existing sequences within the repository are indexed according to the mapper. After the read links are generated for the reads within a similarity distance to a substring of the repository, the remaining reads may be assembled using an off-the-shelf (or custom) assembler, and then added to the repository for further compression of remaining reads and generation of link tables in the manner previously described. Preferably, any mapper at this stage should have an option to find and report only a single matching location in the repository to the sequence query (which may be the full read or a partial read). Note that a single match is enough for compressing a unique read sequence as a pointer and a link, but generally it is insufficient to report this sequence match confidently as the correct mapping (because, typically, an accurate mapping can only be generated after all or most similar locations in the reference genome are identified for the full read sequence).

While the embodiment described above involves just a single reference genome, this is not a limitation, as the framework may be used to provide the mapping to one or more reference genomes, or to a scaffold of multiple sub-genomes.

The techniques of this disclosure provide numerous advantages. Indeed, the challenge of next generation sequencing read data is especially acute given the limits of data storage and analysis. Massive amounts of NGS reads (snippets of genomic sequences of size 35-150 base pairs) are generated daily from sequencing machines, and this data is growing annually at a faster exponential rate than computing power. These reads form the bulk of genomic sequences that need to be stored and analyzed. As existing read mapping methods (BWA, Bowtie/Bowtie2, mrsFAST, GemMapper, and others) search for all seed k-mers from a read data set in an indexed reference genome, their analysis time and storage requirements scale linearly in the size of the full read dataset and therefore effectively grow exponentially slower every year. Compressive genomics, whereby data is compressed in such a way that it can be searched efficiently and accurately without decompressing first, can address some of these issues. Compressive genomics exploits the redundancy of genomic sequences to enable parsimonious storage and fast access. It has been demonstrated previously that search algorithms (such as BLAST and BLAT) could be adapted to run in a compressive genomics framework. This has some utility for processing NGS data, because it allows the search or mapping of a fragment to a compressed collection of similar genomes. On the other hand, most mappers today use some compressive techniques to efficiently index a single reference genome. As noted above, however, all current methods still require going one-by-one through each read to map it onto the compressed representation, resulting in the linear performance dependence on the amount of read data. To use the full power of the large NGS datasets, an approach that (ignoring input/output cost) scales sublinearly in the size of the full read data (i.e., those that reduce the effective size or ignore most of the data) is required. The compressively-accelerated mapping technique of this disclosure is such an approach.

As explained above, the approach of this disclosure leverages a biological observation that, while read mapping algorithms such BWA and Bowtie are designed to be efficient for mapping individual genomes (and indeed scale nearly sublinearly in the size of the reference genome), large-scale NGS read libraries have an additional important characteristic, namely, that they are highly redundant. For example, read data sets, such as those from Genome 10K and 1000 Genomes projects, are also redundant due to the high similarity across individuals. The technique of this disclosure exploits sequence similarity between related NGS samples to make mapping of a large number of closely-related read samples faster.

The framework takes advantage of the redundancy across individuals inherent, but not readily apparent, in large-scale NGS “raw” read data sets to achieve nearly sublinear-time/space paired-end read mapping. As described, the framework searches for seeds extracted from a compressed and indexed read repository, and then refines the search results by efficiently reconstructing the desired set of reads (across all individuals in the read repository) that are relevant to the reference genomic region being investigated. The approach leverages succinct data structures for compressed read representation, and known read mapping algorithms for rapid on-demand retrieval of mapping information.

As additional features, the framework may be extended to include incorporation of flexible mapping modes that have been previously suggested (e.g., best, unique, top-stratum, all-to-reference, and others); in every case, the user can set a threshold for tolerance of indels and mismatches. Identification of all possible mappings is critical for many downstream analyses; for example, structural variants are often found in repeat regions, thus, preferably all mappings are required for reliable prediction or analysis of such variants. Moreover, tolerance to indels and mismatches is important, as most existing methods would deteriorate dramatically with respect to runtime and/or accuracy as a result of variable sequencing errors in experimental protocols and the potential incompleteness of reference genomes.

The compressive mapping technique of this disclosure has been implemented using compressive versions of BWA, Bowtie and mrsFAST that find all possible mapping locations in time proportional to the size of the compressed read data, and sublinearly to the size of the raw input read data. BWA and Bowtie were selected because they are widely used and also the primary means by which many biotechnology laboratories map large NGS read data sets. The improvement to BWA or Bowtie provided by the approach described herein improves various analyses on large read data sets. A compressive version of mrsFAST, one of the fastest mapping algorithms, was also tested. The approach was also compared with GemMapper, another fast mapping program. Notably, the compressive architecture for accelerated mapping described herein allows these existing read mapping methods to be harnessed without modification. In this evaluation, the read alignment performance of the compressive mappers was analyzed against their original versions using datasets with large numbers of individuals, including high-coverage paired-end read datasets (size 50-100 bps) using the 1000 Genomes Phase 1 NGS. The framework achieved near sublinear-time mapping performance with as low depth coverage as 15×, with no significant loss of accuracy, and about an order of magnitude faster than the original read mappers. As expected, the advantage increased substantially with coverage.

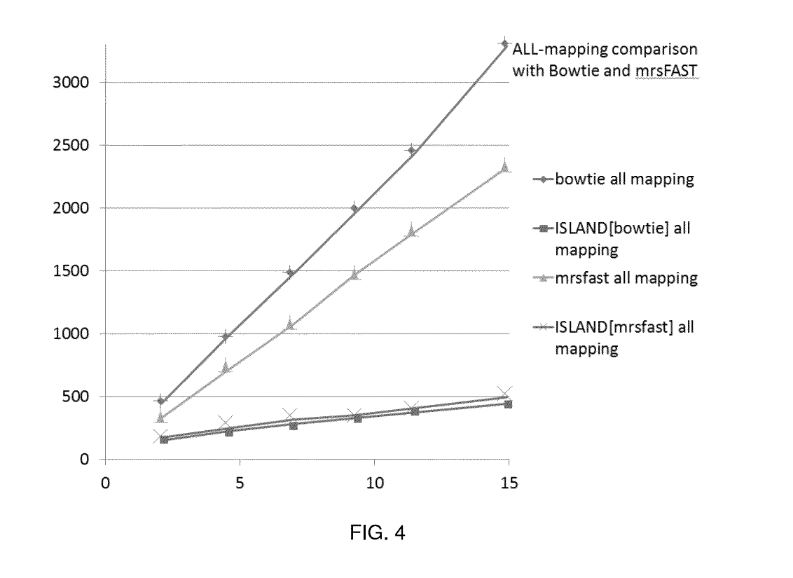

FIG. 4 is a graph illustrating the performance comparisons. In particular, this graph represents the results of compressive mapping of the 1000 Genomes Phase 1 NGS read data sets (all-mapping for single-end 50 bp reads on 6 individuals) as compared with relevant state-of-the-art methods for typical mapping scenarios; the graph shows run-times of Bowtie, compressive Bowtie (referred to as ISLAND[bowtie])), mrsFAST, and compressive mrsFAST (referred to ISLAND[mrsfast]) for all-mapping, which seeks to find all hits within a specified similarity measure. FIG. 4 is a line-connected scatterplot, with the x-axis representing depth coverage values (with each data point corresponding to one or more individuals), and the y-axis is single core run-time.

The framework provides numerous advantages.

In particular, the framework provides a compact read repository. Great gains in storage (and speed) can be achieved within the context of the framework. Assuming 0.5% variability across two random humans and ˜3.2 billion nucleotides in an individual, a compressed repository that efficiently stores single nucleotide variants, structural variants and transcriptional variants across 10000 individuals, is estimated to take only 175 billion nucleotides to represent (<35 GBs of disk space). If sequencing reads from these individuals (with 10×) coverage were compressed and stored separately, they would take more than 6 TB to store. Furthermore, in a preliminary links-table construction experiment using a high-throughput transcriptome sequencing (RNA-seq) data set of 8 individuals, it was possible to achieve up to 200-fold compression from the original data set containing read sequences to a compact links table for representing pointers to the repository and individual edits. As the number of samples increase, the compression rate is expected to significantly increase as well, due to higher redundancy that the links-table representation effectively exploits. These high compression rate results for both the read repository and links-table promise significant improvements in storage efficiency for large scale genomic research.

The framework also provides an efficient locus-specific alignment tool. Existing short-read mapping methods conventionally search for seed k-mers in an indexed reference genome. In contrast, the framework herein in effect applies the reverse search, as the framework makes it possible to search for seeds extracted from the genome in the indexed read repository and efficiently reconstruct the complete set of reads—across all individuals in the read repository—that are relevant to the genomic region being investigated. As described, this NGS read alignment model significantly improves the speed of locus-specific biological analyses for hypothesis-driven biological studies.

The framework also provides a novel sequence alignment model that postpones data-specific mapping decisions from pre-processing to post-processing. Apart from storing read data sets, another issue that arises with the data explosion is the cost of redesigning mapping experiments. There are a plethora of available short-read mappers to be used with genomic/transcriptomic sequencing data, each with many parameters to configure; their algorithmic approaches and mapping capabilities greatly differ and thus the alignment results do as well. Thus, foresight and careful analysis of the sequencing experiment, organism/tissue sequenced, and locus of interest are required to select the optimal mapping approach and parameters before any downstream biological analyses are performed. The framework effectively postpones the alignment step to a later stage of analysis. After initial processing of the read set to build the required data structures, the framework allows very efficient locus-specific mapping that requires analysis of neither the entire read data set nor the whole genome. This alignment model also allows fast mapping from novel reference sequences to the read repository without the need to scan and align the entire read data set to the newly introduced reference. This feature, in practice, allows efficient elimination of contaminants within read data sets as well as identification of reads originating from known novel sequences that are not represented in the reference genome.

The framework also advantageously provides for a secure client-server (or cloud-based computing) model for large-scale genomics. As has been described, the framework allows compressed read storage and analysis in two disjoint components (i.e. the read repository and links-table). In one example scenario, these components are implemented in a client-server model for high-throughput genomics that represents redundant read sequences within a compact read repository stored on the server (which does not maintain individual sequence information, thus allowing sharing by multiple laboratories), and sensitive DNA information in efficient links-table structures within private clients owned by individual research groups. This de-coupled client-server model surmounts the impending genomic data explosion by cutting computing resources (e.g., on the order of 100-fold) needed for storing NGS datasets, and by performing locus-specific search. Such an approach (which is not intended to be limiting) allows terabyte-scale genomics research even with modest computing resources. Coupled with cloud-computing, the framework overcomes challenges in storage and analysis of petabyte-scale genomics research.

The framework significantly advances the state-of-the-art in storage, retrieval and analysis of rapidly expanding genomic sequence datasets, and in particular in adapting the recently introduced concept of “compressive genomics” to short-read sequences generated by high-throughput sequencing technology, i.e., algorithms that can analyze data stored in a compressed format directly, without uncompressing it first. As explained below (e.g., with respect to autism research), the methods herein facilitates addressing many terabyte-scale genomics problems, hopefully leading to novel discoveries about their organization and functioning.

### Variants and Applications

In addition to mapping, the framework may be used in situations where the generated read data set might be revisited for further analyses or verification purposes. It compactly stores the sequencing data so that it can be efficiently re-accessed on demand, even with a new target sequence. A potential application of this use-case is sequence-based haplotype reconstruction. As heterozygous SNP loci relevant to haplotype reconstruction is a small portion of the full genome sequence, an inherent advantage of the framework within the context of haplotype reconstruction is efficient pruning of reads that are irrelevant to SNP loci during mapping. With this approach, it is not necessary to generate the entirety of mappings from the read dataset to the reference, but only mappings that will affect decisions in downstream haplotype reconstruction.

The discovery of genetic factors behind autism provides a specific example of where this approach may be useful. Autism is a common neurodevelopmental disorder with a substantial genetic component. Despite the identification of many genes linked to disease, currently known genetic factors explain a relatively small fraction of autism cases. As sequencing has become cheaper, it is now possible to view individual variations on a large scale to detect over-arching patterns. Autism sequencing data has increased to over 100 terabytes, however, the bulk of sequences that need to be stored and analyzed exist in the form of reads. That said, merely mapping reads from a medium-sized cohort onto a reference requires tremendous computational time and resources. As a result, large-scale genome-wide haplotype association studies mostly have been limited to pedigree-based (e.g., trios) and/or population-based (i.e., looking at haplotypes in a population) phasing approaches, as opposed to sequence-based phasing, which requires computational analysis of large-scale sequencing datasets. The framework herein may be used for fast mapping and extension of the methods to phasing and analysis of large-scale autism datasets. By applying compressively-accelerated sequence-based phasing methods directly to raw autism sequencing data and at the scale of the whole cohort, the techniques herein facilitate study of haplotypes and compound heterozygosity events in autism with greater statistical power and understanding of the underlying factors. In particular, as noted above, the framework creates a compressed sequence repository by pre-processing read datasets together with a reference scaffold sequence, and collectively represents similar read groups as joint links to this repository. The approach allows automatic pruning of reads that are not relevant to the heterozygous variant loci. As stated above, there is no requirement to generate the entirety of mappings from the read dataset to the reference, but only mappings that affect decisions in downstream haplotype reconstruction. For processing autism sequencing data, a table to record linkage-disequilibrium information read-out from SNPs on heterozygous loci and their genomic neighborhoods is maintained. With these data structures, existing statistical haplotype phasing methods are then applied efficiently to investigate compound heterozygosity from sequencing data directly.

Apart from storage and data processing costs, data privacy is another concern regarding large-scale genomic data analyses. A recent study shows that even de-identified genomic variation data sets could enable inference of the family names of the samples. Such concerns about privacy combined with the heavy-dependency on cloud-computing for large-scale genomic data storage and analyses, raises the question of how much of the information within large NGS read datasets is essentially sensitive. For instance, unlike read sequences comprised of nucleotides, read names or quality scores within sequencing data that form the bulk of the storage needed do not contain personally identifiable information and thus do not pose a privacy concern. Furthermore, even within read sequences themselves, only the variation of the individuals from a common reference template sequence and amongst each other will contain sensitive information. Therefore, for storage of large-scale genomic sequencing data, methods such as described herein can support separate compressive storage of personally identifiable information within NGS read datasets and thus facilitate large-scale data processing on sensitive genomic data.

### Enabling Technologies

Next generation sequencing (NGS) technologies, tools, methods and products are well-known. Off-the-shelf read mapper programs include, without limitation, Bowtie, BWA, mrsFAST, and others.

Computing technologies likewise are well-known. A platform that implements the above-described techniques may include both sequencing and computing technologies.

The framework may be implemented in software, in hardware, or in a combination of hardware and software. A software infrastructure that implements the framework is a preferred implementation.

More generally, in a non-limiting embodiment, the framework comprises machines, systems, sub-systems, applications, databases, interfaces and other sequencing, computing and read mapper resources.

As noted above, one or more of the data structures comprising the knowledge base of similarity information may be maintained locally or remotely. The compressively-accelerated mapping (in whole or in part) may be implemented in a client-server infrastructure, or in a cloud-based architecture. As is well-known, cloud computing is a model of service delivery for enabling on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. Available services models that may be leveraged in whole or in part for the platform include: Software as a Service (SaaS) (the provider's applications running on cloud infrastructure); Platform as a service (PaaS) (the customer deploys applications that may be created using provider tools onto the cloud infrastructure); Infrastructure as a Service (IaaS) (customer provisions its own processing, storage, networks and other computing resources and can deploy and run operating systems and applications).

The framework may comprise co-located hardware and software resources, or resources that are physically, logically, virtually and/or geographically distinct. Communication networks used to communicate to and from the framework components or services may be packet-based, non-packet based, and secure or non-secure, or some combination thereof.

While the disclosed subject matter has been described in the context of a method or process, the subject disclosure also relates to apparatus for performing the operations herein. This apparatus may be specially constructed for the required purposes, or it may comprise a general-purpose computer selectively activated or reconfigured by a computer program stored in the computer. Such a computer program may be stored in a non-transitory computer readable storage medium, such as, but is not limited to, any type of disk including an optical disk, a CD-ROM, and a magnetic-optical disk, a read-only memory (ROM), a random access memory (RAM), a magnetic or optical card, or any type of media suitable for storing electronic instructions, and each coupled to a computer system bus.

While given components of the framework have been described separately, one of ordinary skill will appreciate that some of the functions may be combined or shared in given data structures, instructions, program sequences, code portions, and the like.

More generally, the techniques described herein are provided using a set of one or more computing-related entities (systems, machines, processes, programs, libraries, functions, or the like) that together facilitate or provide the described functionality described above. In a typical implementation, a representative machine on which the software executes comprises commodity hardware, an operating system, an application runtime environment, and a set of applications or processes and associated data, that provide the functionality of a given system or subsystem. As described, the functionality may be implemented in a standalone machine, or across a distributed set of machines.

Having described our invention, what we now claim is set forth below.

1. A method of mapping sequencing reads from input read data associated with a reference genome, comprising:
in a first phase, constructing a knowledge base comprising a compact representation of the input read data, and a table that store homologies among given regions of the reference genome within a predefined similarity; and
in a second phase, and using the table, extracting from the compact representation reads corresponding to loci of interest;
wherein the extracting step using software executing in a hardware element.

2. The method as described in claim 1 wherein the compact representation of the input read data is a repository of compressed reads.

3. The method as described in claim 2 wherein the extracting step comprises:
sampling one or more seeds from the loci of interest;
using the sampled seeds to identify one or more hits in the repository;
for each of the one or more hits, identifying, from the table, one or more regions homologous to the hit; and
generating a final mapping from the one or more regions.

4. The method as described in claim 1 wherein the knowledge base further includes a read links table comprising a set of pointers to the repository with additional edit information, wherein a link in the read links table enables reconstruction of given input read data using an associated pointer and edit information within the link.

5. The method as described in claim 1 wherein the table is a homology table that is uniquely associated with the reference genome.

6. The method as described in claim 1 wherein the first phase is performed in a pre-processing stage, and the second phase is performed at a run-time stage.

7. The method as described in claim 1 wherein the extracting step uses a read mapper.

8. The method as described in claim 7 wherein the read mapper is one of: Bowtie, BWA, mrsFAST and GEMmapper.

9. The method as described in claim 1 wherein the compact representation of the input read data is accessible as a service.

10. The method as described in claim 1 wherein the compact representation is constructed by:
collapsing identical or partially identical reads; and
compressing remaining reads with respect to the reference genome.

11. An article comprising a non-transitory machine-readable medium that stores a program, the program being executable to map sequencing reads from input read data associated with a reference genome, comprising:
first program code operative to construct a knowledge base comprising a compressed repository of the input read data, and a homology table that store homologies among given regions of the reference genome within a predefined similarity; and
second program code operative to extract from the compressed repository reads corresponding to loci of interest by sampling one or more seeds from the loci of interest, using the sampled seeds to identify one or more hits in the repository, for each of the one or more hits, identifying, from the homology table, one or more regions homologous to the hit, and generating a mapping from information in the one or more identified regions.

12. The article as described in claim 11 wherein the knowledge base further includes a read links table comprising a set of pointers to the repository with additional edit information, wherein a link in the read links table enables reconstruction of given input read data using an associated pointer and edit information within the link.

13. The article as described in claim 11 wherein the second program code includes a read mapper.

14. Apparatus, comprising:
a data store holding a knowledge base, the knowledge base comprising a compact representation of input read data, and a table that store homologies among given regions of a reference genome within a predefined similarity; and
a computing entity that uses the table to extract from the compact representation reads corresponding to loci of interest.

15. The apparatus as described in claim 14 wherein the compact representation of the input read data is a repository of compressed reads.

16. The apparatus as described in claim 15 wherein the computing entity extracts reads corresponding to the loci of interest by:
sampling one or more seeds from the loci of interest;
using the sampled seeds to identify one or more hits in the repository;
for each of the one or more hits, identifying, from the table, one or more regions homologous to the hit; and
generating a final mapping from the one or more regions.
